(19) United States
(12) Patent Application Publication
(10) Pub. No.: US 2017/0066129 A1
(43) Pub. Date: Mar. 9, 2017

(54) ROBOT, CONTROL APPARATUS, AND ROBOT SYSTEM

(71) Applicant: Seiko Epson Corporation, Tokyo (JP)

(72) Inventors: Masaki MOTOYOSHI, Azumino (JP); Ryosuke IMAI, Matsumoto (JP); Shunsuke TOSHIMITSU, Azumino (JP)

(21) Appl. No.: 15/257,003

(22) Filed: Sep. 6, 2016

(30) Foreign Application Priority Data
Sep. 7, 2015 (JP) 2015-175431

(51) Int. Cl. B25J 9/16

(52) U.S. Cl. CPC B25J 9/1651

(57) ABSTRACT

A robot includes an nth (n is an integer equal to or more than one) arm rotatable about an nth rotation axis, and an (n+1)th arm provided on the nth arm to be rotatable about an (n+1)th rotation axis in an axis direction different from an axis direction of the nth rotation axis, wherein a length of the nth arm is longer than a length of the (n+1)th arm, the nth arm and the (n+1)th arm can overlap as seen from the axis direction of the (n+1)th rotation axis, and a shortest time taken for a second action of rotating the (n+1)th arm from a first attitude to a first angle is shorter than a shortest time taken for a first action of rotating the nth arm from the first attitude to the first angle.

### BACKGROUND

1. Technical Field

The present invention relates to a robot, a control apparatus, and a robot system.

2. Related Art

In related art, robots with robot arms are known. In the robot arm, a plurality of arms (arm members) are coupled via joint parts and, as an end effector, e.g. a hand is attached to the arm on the most distal end side (on the most downstream side). The joint parts are driven by motors and the arms rotate by the driving of the joint parts. Then, for example, the robot grasps an object with the hand, moves the object to a predetermined location, and performs predetermined work such as assembly.

As the robot, Patent Document 1 (JP-A-2014-46401) discloses a vertical articulated robot. In the robot described in Patent Document 1, an action of moving a hand with respect to a base to a position different by 180° about a first rotation axis as a rotation axis (rotation axis extending in vertical directions) at the most proximal end side (on the most upstream side) is performed by rotation of a first arm as an arm at the most proximal end side (base side) with respect to the base about the first rotation axis.

In the robot described in Patent Document 1, when the hand is moved to the position different by 180° about the first rotation axis with respect to the base, a large space is required in order to prevent interferences of the robot.

### SUMMARY

An advantage of some aspects of the invention is to solve at least a part of the problems described above, and can be implemented as the following forms.

A robot according to an aspect of the invention includes an nth (n is an integer equal to or more than one) arm rotatable about an nth rotation axis, and an (n+1)th arm provided on the nth arm to be rotatable about an (n+1)th rotation axis in an axis direction different from an axis direction of the nth rotation axis, wherein a length of the nth arm is longer than a length of the (n+1)th arm, the nth arm and the (n+1)th arm can overlap as seen from the axis direction of the (n+1)th rotation axis, and a shortest time taken for a second action of rotating the (n+1)th arm from a first attitude to a first angle is shorter than a shortest time taken for a first action of rotating the nth arm from the first attitude to the first angle.

According to the robot, the nth arm and the (n+1)th arm can overlap as seen from the axis direction of the (n+1)th rotation axis, and a space for preventing interferences of the robot may be made smaller. Further, the robot according to the aspect of the invention is adapted so that the shortest time of the (n+1)th arm may be shorter than the shortest time of the nth arm when the nth arm and the (n+1)th arm are respectively independently rotated to the same angle. Accordingly, in the action in which the respective arms are simultaneously moved, when the (n+1)th arm is rotated more largely than the nth arm, the respective arms may be rotated without excessive degradation of the performances of the respective arms.

In the robot according to the aspect of the invention, it is preferable that a maximum velocity of the (n+1)th arm is larger than a maximum velocity of the nth arm.

With this configuration, in the action in which the respective arms are simultaneously moved, when the (n+1)th arm is rotated more largely than the nth arm, the respective arms may be rotated without excessive degradation of the performances of the respective arms.

In the robot according to the aspect of the invention, it is preferable that a maximum acceleration of the (n+1)th arm is larger than a maximum acceleration of the nth arm.

With this configuration, in the action in which the respective arms are simultaneously moved, when the (n+1)th arm is rotated more largely than the nth arm, the respective arms may be rotated without excessive degradation of the performances of the respective arms.

In the robot according to the aspect of the invention, it is preferable that the second action is performed via a state in which the nth arm and the (n+1)th arm overlap as seen from the axis direction of the (n+1)th rotation axis.

As described above, according to the robot of the aspect of the invention, the action via the state in which the nth arm and the (n+1)th arm overlap may be performed. In the action, the (n+1)th arm is rotated more largely than the nth arm for reduction of the space for preventing the interferences of the robot. Accordingly, as described above, the shortest time of the (n+1)th arm is set to be shorter than the shortest time of the nth arm, and thereby, also, in the action, the respective arms may be rotated without excessive degradation of the performances of the respective arms.

In the robot according to the aspect of the invention, it is preferable that an (n+2)th arm is provided on the (n+1)th arm and rotatable about an (n+2)th rotation axis parallel to the (n+1)th rotation axis, wherein the (n+1)th arm and the (n+2)th arm can overlap as seen from the axis direction of the (n+1)th rotation axis.

With this configuration, for example, in the robot having a hand on the distal end of the arm, the movable range of the hand may be made wider.

In the robot according to the aspect of the invention, it is preferable that a shortest time taken for a third action of rotating the (n+2)th arm from the first attitude to the first angle is shorter than a shortest time taken for the second action of the (n+1)th arm.

As described above, the shortest time of the (n+2)th arm may be shorter than the shortest time of the (n+1)th arm when the (n+1)th arm and the (n+2)th arm are respectively independently rotated to the same angle. Accordingly, in the action in which the (n+1)th arm and the (n+2)th arm are simultaneously moved, when (n+2)th arm is rotated more largely than the (n+1)th arm, the (n+1)th arm and the (n+2)th arm may be rotated without excessive degradation of the performances of the (n+1)th arm and the (n+2)th arm.

In the robot according to the aspect of the invention, it is preferable that the third action is performed via a state in which the (n+2)th arm and the (n+1)th arm overlap as seen from the axis direction of the (n+1)th rotation axis.

As described above, according to the robot of the aspect of the invention, the action via the state in which the (n+1)th arm and the (n+2)th arm overlap may be performed. In the action, the (n+2)th arm is rotated more largely than the (n+1)th arm for reduction of the space for preventing the interferences of the robot. Accordingly, as described above, the shortest time of the (n+2)th arm is set to be shorter than the shortest time of the (n+1)th arm, and thereby, also, in the action, the (n+1)th arm and the (n+2)th arm may be rotated without excessive degradation of the performances of the (n+1)th arm and the (n+2)th arm.

In the robot according to the aspect of the invention, it is preferable that, supposing that a ratio of a velocity of the nth arm to the maximum velocity of the nth arm when the nth arm and the (n+1)th arm are simultaneously rotated is RV1 and a ratio of a velocity of the (n+1)th arm to the maximum velocity of the (n+1)th arm when the nth arm and the (n+1)th arm are simultaneously rotated is RV2, a relationship of 0.8≦RV2/RV1<1.0 is satisfied.

With this configuration, in the action in which the nth arm and the (n+1)th arm are simultaneously moved, when the (n+1)th arm is moved more than the nth arm, the respective arms may be rotated without excessive degradation of the performances of the nth arm and the (n+1)th arm.

In the robot according to the aspect of the invention, it is preferable that, supposing that a ratio of an acceleration of the nth arm to a maximum acceleration of the nth arm when the nth arm and the (n+1)th arm are simultaneously rotated is RA1 and a ratio of an acceleration of the (n+1)th arm to a maximum acceleration of the (n+1)th arm when the nth arm and the (n+1)th arm are simultaneously rotated is RA2, a relationship of 0.8≦RA2/RA1<1.0 is satisfied.

With this configuration, in the action in which the nth arm and the (n+1)th arm are simultaneously moved, when the (n+1)th arm is moved more than the nth arm, the respective arms may be moved without excessive degradation of the performances of the nth arm and the (n+1)th arm. Further, the adjustment of the acceleration may be easier than the adjustment of the velocity.

In the robot according to the aspect of the invention, it is preferable that a base is provided on a proximal end side of the nth arm (n is one).

With this configuration, the nth arm and the (n+1)th arm may be rotated with respect to the base.

A control apparatus according to an aspect of the invention controls actions of the robot according to the aspect of the invention.

With this configuration, the control apparatus controlling actions of the robot that may reduce the space for preventing the interferences of the robot may be provided.

A robot system according to an aspect of the invention includes the robot according to the aspect of the invention and a control apparatus controlling actions of the robot.

With this configuration, the robot system including the robot that may reduce the space for preventing the interferences of the robot and the control apparatus controlling actions thereof may be provided.

### BRIEF DESCRIPTION OF THE DRAWINGS

The invention will be described with reference to the accompanying drawings, wherein like numbers reference like elements.

FIG. 1 is a front view showing a preferred embodiment of a robot system according to the invention.

FIG. 2 is a schematic diagram of the robot shown in FIG. 1.

FIG. 3 is a side view of the robot shown in FIG. 1.

FIG. 4 is a side view of the robot shown in FIG. 1.

FIG. 5 is a diagram for explanation of actions of the robot shown in FIG. 1.

FIG. 6 is a diagram for explanation of movement paths of a hand in the actions of the robot shown in FIG. 5.

FIG. 7 shows an example of an attitude of the robot when a distal end of a robot arm is in a point A.

FIG. 8 shows an example of the attitude of the robot when the distal end of the robot arm is in a point B.

FIG. 9 shows another example of the attitude of the robot when the distal end of the robot arm is in the point B.

FIG. 10 shows relationships between arrival times and velocities of a first arm and a second arm in a PTP operation of related art.

FIG. 11 shows the maximum velocity of the first arm and the maximum velocity of the second arm.

FIG. 12 shows respective velocities of the first arm and the second arm when the first arm and the second arm are simultaneously rotated.

FIG. 13 shows the maximum velocity of the second arm and the maximum velocity of a third arm.

FIG. 14 shows respective velocities of the second arm and the third arm when the second arm and the third arm are simultaneously rotated.

FIG. 15 is a diagram for explanation of accelerations of the first arm and the second arm.

### DESCRIPTION OF EXEMPLARY EMBODIMENTS

As below, a robot, a control apparatus, and a robot system according to the invention will be explained in detail based on preferred embodiments shown in the accompanying drawings.

### Robot System

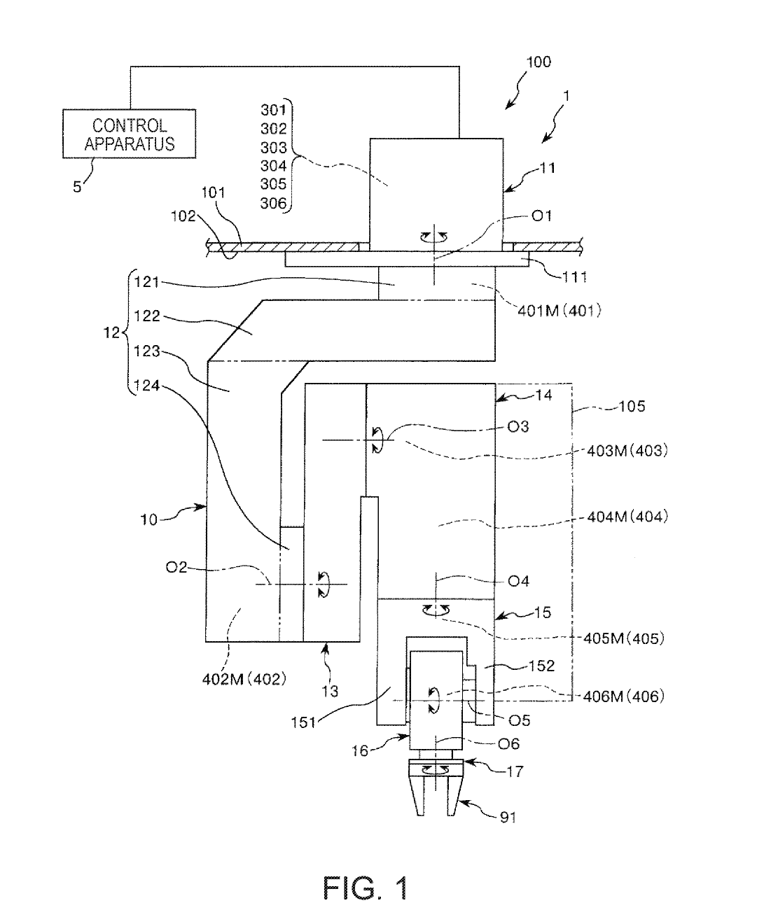

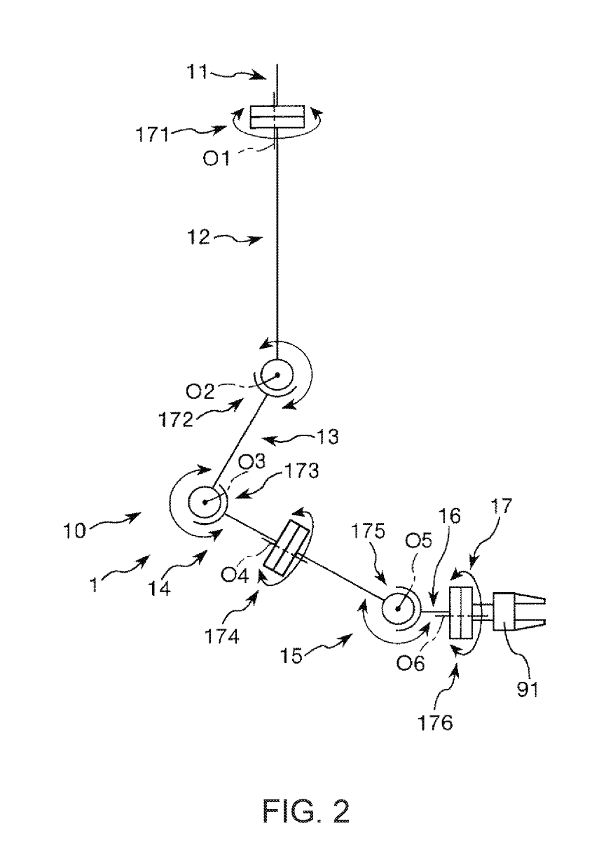

FIG. 1 is a front view showing a preferred embodiment of a robot system according to the invention. FIG. 2 is a schematic diagram of the robot shown in FIG. 1.

Hereinafter, for convenience of explanation, the upside in FIG. 1 is referred to as “up” or “upper” and the downside is referred to as “low” or “lower”. Further, the base side in FIG. 1 is referred to as “proximal end” or “upstream” and the opposite side (the hand side) is referred to as “distal end” or “downstream”. Furthermore, upward and downward directions in FIG. 1 are referred to as “vertical directions” and rightward and leftward directions are referred to as “horizontal directions”.

A robot system 100 shown in FIG. 1 includes a robot 1 and a control apparatus 5 that controls actions of the robot 1. The robot system 100 may be used in a manufacturing process of manufacturing precision apparatuses such as wristwatches or the like.

### Robot

The robot 1 shown in FIG. 1 may perform work of feeding, removing, carrying, and assembly of the precision apparatuses and parts forming the apparatuses.

As shown in FIG. 1, the robot 1 includes a base 11 and a robot arm 10. The robot arm 10 includes a first arm (nth arm) 12, a second arm ((n+1)th arm) 13, a third arm 14, a fourth arm 15, a fifth arm 16, and a sixth arm 17 (six arms), and a first drive source 401, a second drive source 402, a third drive source 403, a fourth drive source 4O4, a fifth drive source 405, and a sixth drive source 406 (six drive sources).

For example, an end effector such as a hand 91 that grasps a precision apparatus, a part, or the like may be detachably attached to the distal end of the sixth arm 17.

The robot 1 is a vertical articulated (six-axis) robot in which the base 11, the first arm 12, the second arm 13, the third arm 14, the fourth arm 15, the fifth arm 16, and the sixth arm 17 are sequentially coupled from the proximal end side toward the distal end side.

As below, the first arm 12, the second arm 13, the third arm 14, the fourth arm 15, the fifth arm 16, and the sixth arm 17 will be respectively also referred to as “arm”. The first drive source 401, the second drive source 402, the third drive source 403, the fourth drive source 4O4, the fifth drive source 405, and the sixth drive source 406 will be respectively also referred to as “drive source (drive unit)”.

Base

As shown in FIG. 1, when the robot 1 is a suspended vertical articulated robot, the base 11 is a part located uppermost in the robot 1 and fixed (member attached) to e.g. an attachment surface 102 as a lower surface of a ceiling 101 as an installation space of the robot 1.

Note that, in the embodiment, a plate-like flange 111 provided in the lower part of the base 11 is fixed to the attachment surface 102, however, the part fixed to the attachment surface 102 is not limited to that. For example, the part may be an upper surface of the base 11. The fixing method is not particularly limited, but e.g. a fixing method using a plurality of bolts or the like may be employed.

The location to which the base 11 is fixed is not limited to the ceiling of the installation space, but may be e.g. a wall, a floor, a ground of the installation space.

### Robot Arm

The robot arm 10 shown in FIG. 1 is rotatably supported with respect to the base 11 and the arms 12 to 17 are respectively supported to be independently displaceable with respect to the base 11.

The first arm 12 has a bending shape. The first arm 12 has a first portion 121 connected to the base 11 and extending downward in the vertical direction from the base 11, a second portion 122 extending in the horizontal direction from the lower end of the first portion 121, a third portion 123 provided on an opposite end of the second portion 122 to the first portion 121 and extending in the vertical direction, and a fourth portion 124 extending in the horizontal direction from the distal end of the third portion 123. These first portion 121, second portion 122, third portion 123, and fourth portion 124 are integrally formed. Further, the second portion 122 and the third portion 123 are nearly orthogonal (crossing) as seen from the near side of the paper surface of FIG. 1 (in a front view orthogonal to both a first rotation axis O1 and a second rotation axis O2, which will be described later).

The second arm 13 has a longitudinal shape and is connected to the distal end of the first arm 12 (the opposite end of the fourth portion 124 to the third portion 123).

The third arm 14 has a longitudinal shape and is connected to the opposite end of the second arm 13 to the end to which the first arm 12 is connected.

The fourth arm 15 is connected to the opposite end of the third arm 14 to the end to which the second arm 13 is connected. The fourth arm 15 has a pair of supporting portions 151, 152 opposed to each other. The supporting portions 151, 152 are used for connection to the fifth arm 16.

The fifth arm 16 is located between the supporting portions 151, 152 and connected to the supporting portions 151, 152, and thereby, coupled to the fourth arm 15. Note that the structure of the fourth arm 15 is not limited to the structure, but may have one supporting portion (cantilever).

The sixth arm 17 has a flat plate shape and is connected to the distal end of the fifth arm 16. Further, the hand 91 is detachably attached to the distal end of the sixth arm 17 (the opposite end to the fifth arm 16). The hand 91 includes, but not particularly limited to, e.g. aconfiguration having a plurality of finger portions (fingers).

Each of the exteriors of the above described respective arms 12 to 17 may be formed by a single member or a plurality of members.

Next, referring to FIG. 2, the drive sources 401 to 406 with driving of these arms 12 to 17 will be explained.

As shown in FIG. 2, the base 11 and the first arm 12 are coupled via a joint (connecting part) 171. The base 11 may include the joint 171 or not.

The joint 171 has a mechanism that rotatably supports the first arm 12 coupled to the base 11 with respect to the base 11. Thereby, the first arm 12 is rotatable around the first rotation axis (nth rotation axis) O1 in parallel to the vertical direction (about the first rotation axis O1) with respect to the base 11. Further, the first rotation axis O1 is a rotation axis on the most upstream side of the robot 1. The rotation about the first rotation axis O1 is performed by driving of the first drive source 401 having a motor 401M. Further, the first drive source 401 is driven by the motor 401M and a cable (not shown), and the motor 401M is controlled by the control apparatus 5 via a motor driver 301 electrically connected thereto. Note that the first drive source 401 may be adapted to transmit the drive power from the motor 401M by a reducer (not shown) provided with the motor 401M, or the reducer may be omitted.

The first arm 12 and the second arm 13 are coupled via a joint (connecting part) 172. The joint 172 has a mechanism that rotatably supports one of the first arm 12 and the second arm 13 coupled to each other with respect to the other. Thereby, the second arm 13 is rotatable around the second rotation axis O2 ((n+1)th rotation axis) in parallel to the horizontal direction (about the second rotation axis O2) with respect to the first arm12. The second rotation axis O2 is orthogonal to the first rotation axis O1. The rotation about the second rotation axis O2 is performed by driving of the second drive source 402 having a motor 402M. Further, the second drive source 402 is driven by the motor 402M and a cable (not shown), and the motor 402M is controlled by the control apparatus 5 via a motor driver 302 electrically connected thereto. Note that the second drive source 402 may be adapted to transmit the drive power from the motor 402M by a reducer (not shown) provided with the motor 402M, or the reducer may be omitted. The second rotation axis O2 may be parallel to the axis orthogonal to the first rotation axis O1, or the second rotation axis O2 may be different in axis direction from the first rotation axis O1, not orthogonal thereto.

The second arm 13 and the third arm 14 are coupled via a joint (connecting part) 173. The joint 173 has a mechanism that rotatably supports one of the second arm 13 and the third arm 14 coupled to each other with respect to the other. Thereby, the third arm 14 is rotatable around a third rotation axis O3 in parallel to the horizontal direction (about the third rotation axis O3) with respect to the second arm 13. The third rotation axis O3 is parallel to the second rotation axis O2. The rotation about the third rotation axis O3 is performed by driving of the third drive source 403. Further, the third drive source 403 is driven by a motor 403M and a cable (not shown), and the motor 403M is controlled by the control apparatus 5 via a motor driver 303 electrically connected thereto. Note that the third drive source 403 may be adapted to transmit the drive power from the motor 403M by a reducer (not shown) provided with the motor 403M, or the reducer may be omitted.

The third arm 14 and the fourth arm 15 are coupled via a joint (connecting part) 174. The joint 174 has a mechanism that rotatably supports one of the third arm 14 and the fourth arm 15 coupled to each other with respect to the other. Thereby, the fourth arm 15 is rotatable around a fourth rotation axis O4 in parallel to the center axis direction of the third arm 14 (about the fourth rotation axis O4) with respect to the third arm 14. The fourth rotation axis O4 is orthogonal to the third rotation axis O3. The rotation about the fourth rotation axis O4 is performed by driving of the fourth drive source 4O4. Further, the fourth drive source 4O4 is driven by a motor 4O4M and a cable (not shown), and the motor 4O4M is controlled by the control apparatus 5 via a motor driver 3O4 electrically connected thereto. Note that the fourth drive source 4O4 may be adapted to transmit the drive power from the motor 4O4M by a reducer (not shown) provided with the motor 4O4M, or the reducer may be omitted. The fourth rotation axis O4 may be parallel to the axis orthogonal to the third rotation axis O3, or the fourth rotation axis O4 may be different in axis direction from the third rotation axis O3, not orthogonal thereto.

The fourth arm 15 and the fifth arm 16 are coupled via a joint (connecting part) 175. The joint 175 has a mechanism that rotatably supports one of the fourth arm 15 and the fifth arm 16 coupled to each other with respect to the other. Thereby, the fifth arm 16 is rotatable around a fifth rotation axis O5 orthogonal to the center axis direction of the fourth arm 15 (about the fifth rotation axis O5) with respect to the fourth arm 15. The fifth rotation axis O5 is orthogonal to the fourth rotation axis O4. The rotation about the fifth rotation axis O5 is performed by driving of the fifth drive source 405. Further, the fifth drive source 405 is driven by a motor 405M and a cable (not shown), and the motor 405M is controlled by the control apparatus 5 via a motor driver 305 electrically connected thereto. Note that the fifth drive source 405 may be adapted to transmit the drive power from the motor 405M by a reducer (not shown) provided with the motor 405M, or the reducer may be omitted. The fifth rotation axis O5 may be parallel to the axis orthogonal to the fourth rotation axis O4, or the fifth rotation axis O5 may be different in axis direction from the fourth rotation axis O4, not orthogonal thereto.

The fifth arm 16 and the sixth arm 17 are coupled via a joint (connecting part) 176. The joint 176 has a mechanism that rotatably supports one of the fifth arm 16 and the sixth arm 17 coupled to each other with respect to the other. Thereby, the sixth arm 17 is rotatable around a sixth rotation axis O6 (about the sixth rotation axis O6) with respect to the fifth arm 16. The sixth rotation axis O6 is orthogonal to the fifth rotation axis O5. The rotation about the sixth rotation axis O6 is performed by driving of the sixth drive source 406. Further, the sixth drive source 406 is driven by a motor 406M and a cable (not shown), and the motor 406M is controlled by the control apparatus 5 via a motor driver 306 electrically connected thereto. Note that the sixth drive source 406 may be adapted to transmit the drive power from the motor 406M by a reducer (not shown) provided with the motor 406M, or the reducer may be omitted. The fifth rotation axis O5 may be parallel to the axis orthogonal to the fourth rotation axis O4, the sixth rotation axis O6 may be parallel to the axis orthogonal to the fifth rotation axis O5, or the sixth rotation axis O6 may be different in axis direction from the fifth rotation axis O5, not orthogonal thereto.

The robot 1 driving in the above described manner controls the actions of the arms 12 to 17 etc. while grasping a precision apparatus, a part, or the like with the hand 91 connected to the distal end of the sixth arm 17, and thereby, may perform respective work of carrying the precision apparatus, the part, etc. The driving of the hand 91 is controlled by the control apparatus 5.

### Control Apparatus

The control apparatus 5 shown in FIG. 1 controls the actions of the robot 1. The control apparatus 5 may be formed using e.g. a personal computer (PC) containing a CPU (Central Processing Unit) or the like.

In the embodiment, the control apparatus 5 is provided separately from the robot 1, however, may be provided inside of the robot 1.

As above, the basic configuration of the robot 1 is briefly explained. The robot 1 having the configuration is the vertical articulated robot having the six (plurality of) arms 12 to 17 as described above, and thereby, the drive range is wider and higher workability may be exerted.

Further, as described above, in the robot 1, the proximal end side of the first arm 12 is attached to the base 11, and thereby, the respective arms 12 to 17 may be rotated with respect to the base 11. Furthermore, the robot 1 is of the suspended type with the base 11 attached to the ceiling 101, and the joint 171 as the connecting part between the base 11 and the first arm 12 is located above the joint 172 as the connecting part between the first arm 12 and the second arm 13 in the vertical direction. Accordingly, the work range of the robot 1 below the robot 1 in the vertical direction may be made wider.

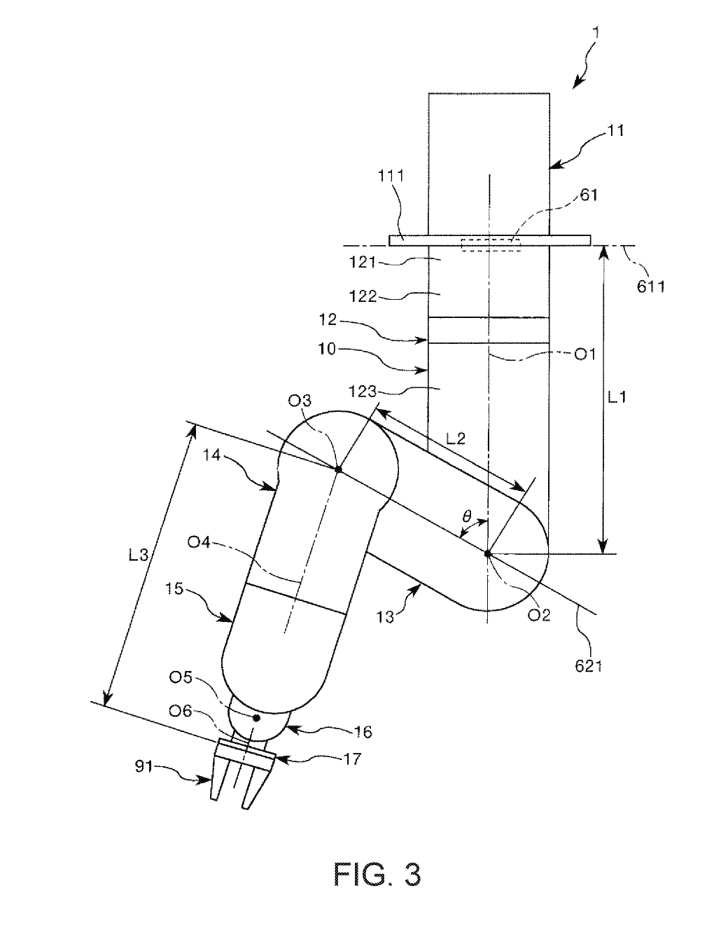

Next, referring to FIGS. 3, 4, 5, and 6, the relationships among the arms 12 to 17 will be explained, and the explanation will be made from various viewpoints with different expressions etc.

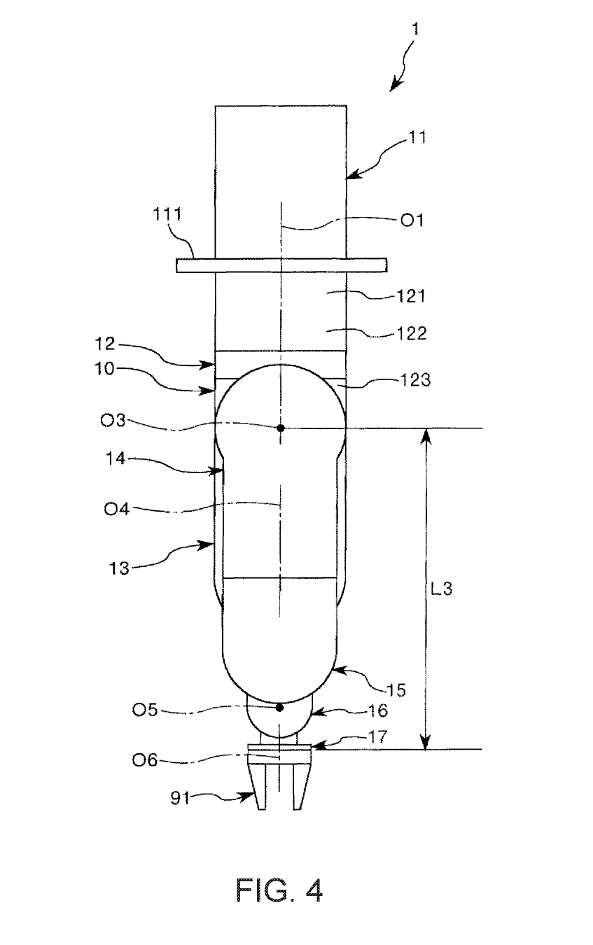

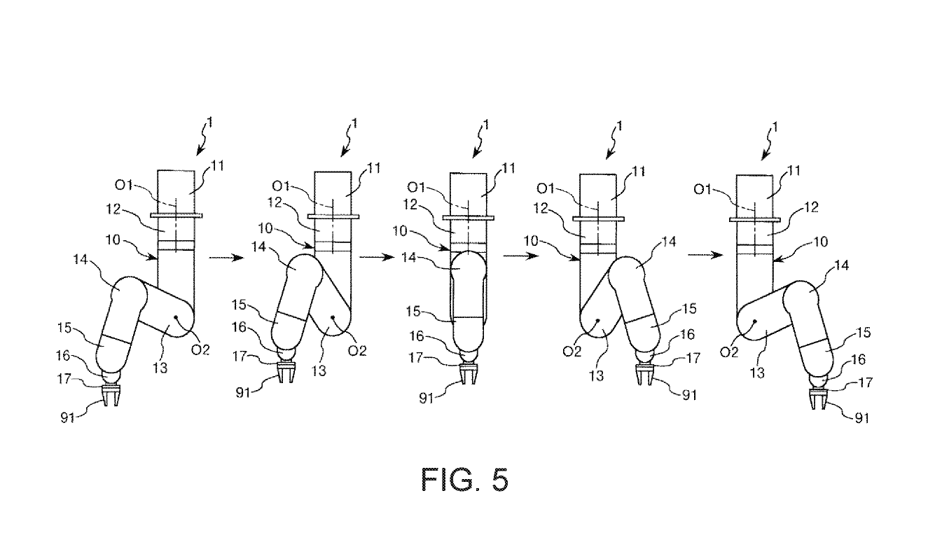

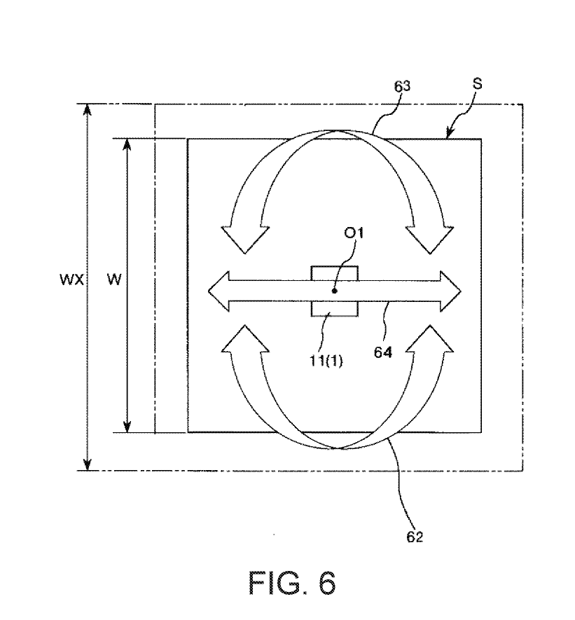

FIG. 3 is a side view of the robot shown in FIG. 1. FIG. 4 is a side view of the robot shown in FIG. 1. FIG. 5 is a diagram for explanation of actions of the robot shown in FIG. 1. FIG. 6 is a diagram for explanation of movement paths of the hand in the actions of the robot shown in FIG. 5.

In the following explanation, the third arm 14, the fourth arm 15, the fifth arm 16, and the sixth arm 17 are considered in a condition that they are stretched straight, in other words, in a condition that the fourth rotation axis O4 and the sixth rotation axis O6 are aligned or in parallel as shown in FIGS. 3 and 4.

First, as shown in FIG. 3, a length L1 of the first arm 12 is set to be longer than a length L2 of the second arm 13.

Here, the length L1 of the first arm 12 is a distance between the second rotation axis O2 and a center line 611 extending in the leftward and rightward directions in FIG. 3 of a bearing part 61 (a member of the joint 171) that rotatably supports the first arm 12 as seen from the axis direction of the second rotation axis O2. Further, the length L2 of the second arm 13 is a distance between the second rotation axis 02 and the third rotation axis O3 as seen from the axis direction of the second rotation axis O2.

Further, as shown in FIGS. 3 and 4, the robot 1 is adapted so that an angle θ formed between the first arm 12 and the second arm 13 can be 0° as seen from the axis direction of the second rotation axis O2. That is, the robot 1 is adapted so that the first arm 12 and the second arm 13 can overlap as seen from the axis direction of the second rotation axis O2. The second arm 13 is adapted so that, when the angle θ is 0°, that is, the first arm 12 and the second arm 13 overlap as seen from the axis direction of the second rotation axis O2, the second arm 13 may not interfere with the second portion 122 of the first arm 12 and the ceiling 101.

Here, the angle θ formed by the first arm 12 and the second arm 13 is an angle formed by a straight line passing through the second rotation axis O2 and the third rotation axis O3 (a center axis of the second arm 13 as seen from the axis direction of the second rotation axis O2) 621 and the first rotation axis O1 as seen from the axis direction of the second rotation axis O2 (see FIG. 3).

Furthermore, as shown in FIG. 4, the robot 1 is adapted so that the second arm 13 and the third arm 14 can overlap as seen from the axis direction of the second rotation axis O2. That is, the robot 1 is adapted so that the first arm 12, the second arm 13, and the third arm 14 can overlap at the same time as seen from the axis direction of the second rotation axis O2.

As shown in FIG. 3, a total length L3 of the third arm 14, the fourth arm 15, the fifth arm 16, and the sixth arm 17 is set to be longer than the length L2 of the second arm 13. Thereby, as shown in FIG. 4, as seen from the axis direction of the second rotation axis O2, when the second arm 13 and the third arm 14 are overlapped, the distal end of the robot arm 10, i.e., the distal end of the sixth arm 17 may be protruded from the second arm 13. Therefore, the hand 91 may be prevented from interfering with the first arm 12 and the second arm 13.

Here, the total length L3 of the third arm 14, the fourth arm 15, the fifth arm 16, and the sixth arm 17 is a distance between the third rotation axis O3 and the distal end of the sixth arm 17 as seen from the axis direction of the second rotation axis O2 (see FIG. 4). In this case, regarding the third arm 14, the fourth arm 15, the fifth arm 16, and the sixth arm 17, the fourth rotation axis O4 and the sixth rotation axis O6 are aligned or in parallel as shown in FIG. 4.

In the robot 1 having the robot arm 10, the above described relationships are satisfied, and thereby, as shown in FIG. 5, by rotation of the second arm 13 and the third arm 14 without rotation of the first arm12, the hand 91 (the distal end of the third arm 14) may be moved to a position different by 180° about the first rotation axis O1 through the state in which the angle θ formed by the first arm 12 and the third arm 13 is 0° (the first arm 12 and the second arm 13 overlap) as seen from the axis direction of the second rotation axis O2.

By the driving of the robot arm 10, as shown in FIG. 6, the robot 1 may perform an action of moving the hand 91 as shown by arrows 64 without actions of moving the hand 91 as shown by arrows 62, 63. That is, the robot 1 may perform the action of moving the hand 91 (the distal end of the robot arm 10) linearly as seen from the axis direction of the first rotation axis O1. Thereby, the space for preventing interferences of the robot 1 may be made smaller. Accordingly, the area S of the installation space for installation of the robot 1 (installation area) may be made smaller than that of related art.

Specifically, as shown in FIG. 6, the width W of the installation space of the robot 1 may be made smaller than a width WX of the installation space of related art, e.g. 80% of the width WX or less. Accordingly, the operation region of the robot 1 in the width direction (the direction of the production line) may be made smaller. Thereby, the larger number of robots 1 may be arranged along the production line per unit length and the production line may be shortened.

Further, similarly, the height of the installation space of the robot 1 (the height in the vertical direction) may be made lower than the height of related art, specifically, e.g. 80% of the height of related art or less.

The action of moving the hand 91 as shown by the arrows 64 can be performed, and, when the hand 91 is moved to a position different by 180° about the first rotation axis O1, for example, the first arm 12 may not be rotated or the rotation angle (amount of rotation) of the first arm 12 may be made smaller. The rotation angle of the first arm 12 about the first rotation axis O1 is made smaller, and thereby, the rotation of the first arm 12 having portions protruding outward from the base 11 (the second portion 122, the third portion 123, and the fourth portion 124) may be made smaller, and interferences of the robot 1 with peripherals may be reduced.

Further, the action of moving the hand 91 as shown by the arrows 64 can be performed and the movement of the robot 1 may be reduced, and thereby, the robot 1 may be efficiently driven. Accordingly, the takt time may be shortened and the work efficiency may be improved. In addition, the distal end of the robot arm 10 may be linearly moved and the movement of the robot 1 may be easily grasped.

Here, to execute the above described action of moving the hand 91 of the robot 1 (the distal end of the robot arm 10) to a position different by 180° about the first rotation axis O1 by simply rotating the first arm 12 about the first rotation axis O1 like the robot of related art, the robot 1 may interfere with the peripherals, and thus, it is necessary to teach the robot 1 an evacuation point for avoiding the interference. For example, in the case where, when only the first arm 12 is rotated to 90° about the first rotation axis O1, the robot 1 also interferes with the peripherals, it is necessary to teach the robot 1 many evacuation points not to interfere with the peripherals. As described above, in the robot of related art, it is necessary to teach many evacuation points, and an enormous number of evacuation points are necessary. Therefore, a lot of effort and time are taken for teaching.

On the other hand, in the robot 1, when the action of moving the hand 91 to a position different by 180° about the first rotation axis O1 is executed, the number of regions and portions that may interfere is very small and the number of evacuation points to teach may be reduced and effort and time which are taken for teaching may be reduced. That is, in the robot 1, the number of evacuation points to teach may be about ⅓ of that of the robot of related art, and teaching is dramatically easier.

In the robot 1, a region (part) 105 of the third arm 14 and the fourth arm 15 surrounded by a dashed-two dotted line on the right in FIG. 1 is a region (part) in which the robot 1 does not or is hard to interfere with the robot 1 itself or other members. Accordingly, when a predetermined member is mounted on the region 105, the member is hard to interfere with the robot 1 and peripherals or the like. Therefore, in the robot 1, a predetermined member may be mounted on the region 105. Particularly, the case where the predetermined member is mounted on a region of the third arm 14 on the right in FIG. 1 of the region 105 is more effective because the probability that the member interferes with peripherals (not shown) is lower.

Objects that can be mounted on the region 105 include e.g. a controller for controlling driving of a sensor of a hand, a hand eye camera, or the like, a solenoid valve for a suction mechanism, etc.

As a specific example, for example, when a suction mechanism is provided on the hand, if a solenoid valve or the like is provided in the region 105, the solenoid valve causes no obstruction when the robot 1 is driven. The region 105 is highly convenient as described above.

The above described robot 1 may move the distal end of the robot arm 10 to a target position by e.g. an operation (PTP operation) by PTP (Point To Point) control.

The PTP operation is an operation by control of designating (teaching) several points (teaching points) from the present position to the target position, however, not designating (restricting) paths of the distal end of the robot arm 10 from certain points to other points and attitudes of the respective arms 12 to 17 in the paths.

Generally, the PTP operation simultaneously moves the respective arms 12 to 17 so that the movement times of the respective arms 12 to 17 may be nearly the same.

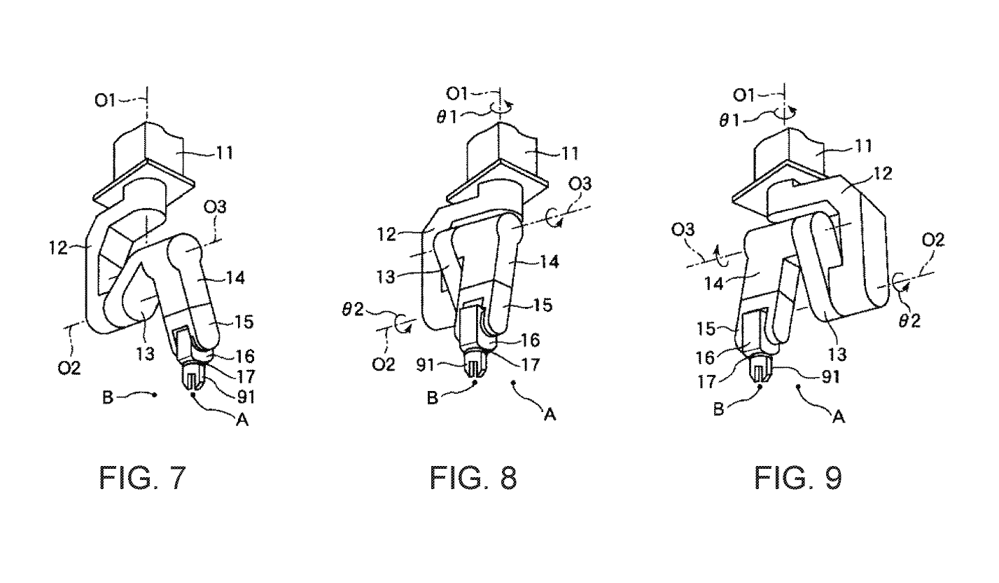

As below, the PTP operation of the robot 1 will be explained with reference to FIGS. 7 to 15.

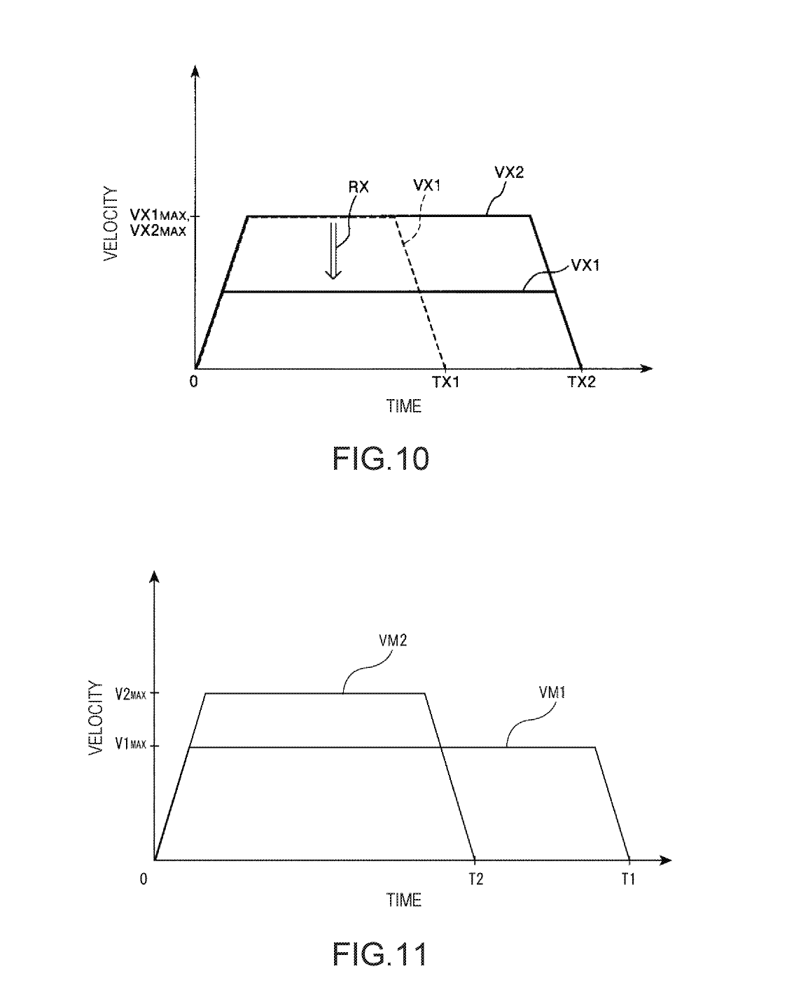

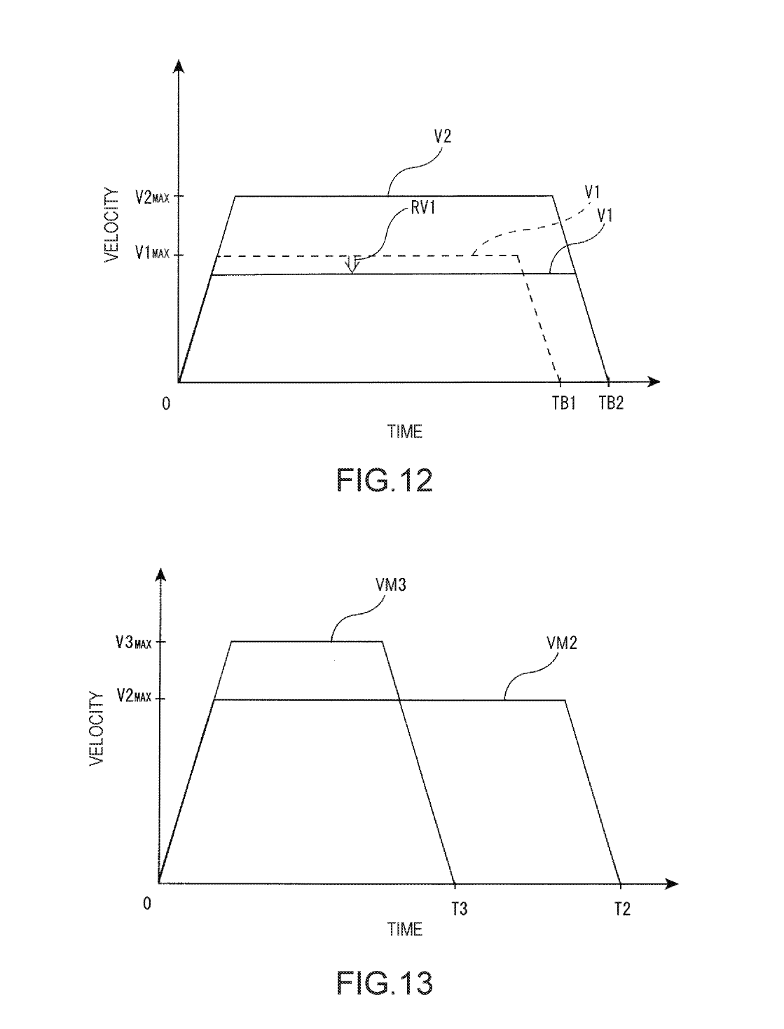

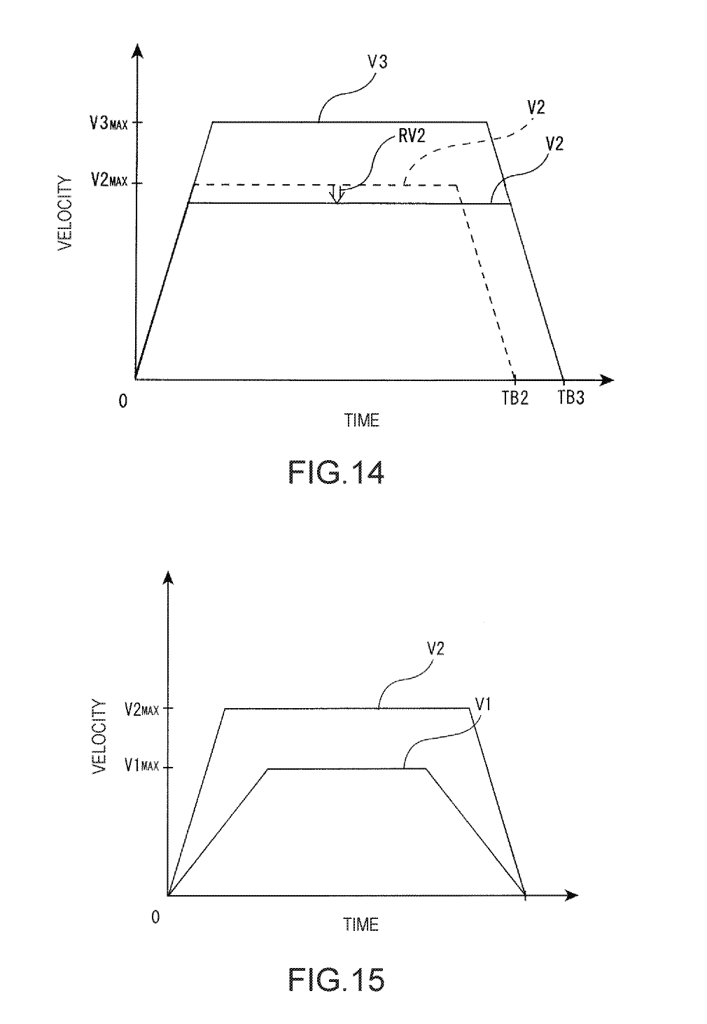

FIG. 7 shows an example of an attitude of the robot when the distal end of the robot arm is in a point A. FIG. 8 shows an example of the attitude of the robot when the distal end of the robot arm is in a point B. FIG. 9 shows another example of the attitude of the robot when the distal end of the robot arm is in the point B. FIG. 10 shows relationships between arrival times and velocities of the first arm and the second arm in a PTP operation of related art. FIG. 11 shows the maximum velocity of the first arm and the maximum velocity of the second arm. FIG. 12 shows respective velocities of the first arm and the second arm when the first arm and the second arm are simultaneously rotated. FIG. 13 shows the maximum velocity of the second arm and the maximum velocity of the third arm. FIG. 14 shows respective velocities of the second arm and the third arm when the second arm and the third arm are simultaneously rotated. FIG. 15 is a diagram for explanation of accelerations of the first arm and the second arm.

In the PTP operation of the robot 1, as described above, the points (teaching points) are designated, however, via points and attitudes to the points are not designated. Accordingly, for example, in the case where the point A and the point B different from each other are set and the distal end of the robot arm 10 is moved from the point A to the point B, it is considered that the robot 1 changes from a state in which the distal end of the robot arm 10 is located at the point Ain the attitude as shown in FIG. 7 to a state in which distal end of the robot arm 10 is located at the point B in the attitude as shown in FIG. 8 or 9, for example.

In the movement to the attitude of the robot 1 as shown in FIG. 8, the first arm 12 and the second arm 13 are rotated so that the rotation angle θ1 of the first arm 12 about the first rotation axis O1 may be smaller than the rotation angle θ2 of the second arm 13 about the second rotation axis O2. That is, in the movement, a relationship of rotation angle O1<rotation angle θ2 is satisfied.

On the other hand, in the movement to the attitude of the robot 1 as shown in FIG. 9, the first arm 12 and the second arm 13 are rotated so that the rotation angle θ1 of the first arm 12 about the first rotation axis O1 may be larger than the rotation angle θ2 of the second arm 13 about the second rotation axis O2. That is, in the movement, a relationship of rotation angle θ2<rotation angle θ1 is satisfied.

As described above, in the robot 1, the interferences of the robot 1 with peripherals may be less in the action with the smaller rotation angle θ1 (the action that satisfies the relationship of rotation angle θ1<rotation angle θ2) like the movement to the attitude of the robot 1 shown in FIG. 8. Accordingly, the PTP operation of the robot 1 of the embodiment is adapted (controlled) to select the action of the first arm 12 with the smaller rotation angle θ1. Note that, hereinafter, the PTP operation of moving the distal end of the robot arm 10 from the point A to the point B by the action with the smaller rotation angle θ1 is simply referred to as “PIP operation shown in FIG. 8”.

Here, as shown in FIG. 10, in the case where the maximum velocity VX1_{MAX}of the first arm 12 and the maximum velocity VX2_{MAX}of the second arm 13 are equal, when the first arm 12 and the second arm 13 are moved at the maximum velocities VX1_{MAX}, VX2_{MAX}, respectively, the first arm 12 rotates at a velocity VX1 as shown by a broken line in FIG. 10 and the second arm 13 rotates at a velocity VX2 as shown by a solid line in FIG. 10. In this case, as shown in FIG. 10, an arrival time TX1 of the first arm 12 is shorter than an arrival time TX2 of the second arm 13.

However, as described above, in the PTP operation, the first arm 12 and the second arm 13 are moved nearly simultaneously so that the respective movement times of the first arm 12 and the second arm 13 may be the same. Accordingly, to make the arrival time TX1 of the first arm 12 equal to the arrival time TX2 of the second arm 13, the first arm 12 rotates at a velocity VX1 as shown by a solid line in FIG. 10. As described above, the velocity VX1 of the first arm 12 should be made significantly smaller (lower) than the velocity VX1 shown by the broken line in FIG. 10 (the velocity at which the first arm 12 is rotated at the maximum velocity VX1_{MAX}). That is, it is necessary to move the first arm 12 at the velocity VX1 lower by a ratio RX with respect to the maximum velocity VX1_{MAX}. Accordingly, there is a problem that the original performance (the maximum velocity) of the first arm 12 is not sufficiently exerted.

Now, in the robot 1 of the embodiment, as shown in FIG. 11, the maximum velocity V2_{MAX} of the second arm 13 is made larger (higher) than the maximum velocity V1_{MAX} of the first arm 12. In other words, in the robot 1, the shortest time T2 of the second arm 13 when the first arm 12 and the second arm 13 are rotated to the same rotation angle is made shorter than the shortest time T1 of the first arm 12.

Note that FIG. 11 shows a velocity VM1 of the first arm 12 and a velocity VM2 of the second arm 13 when the first arm12 and the second arm13 are moved at the maximum velocities VX1_{MAX}, VX2_{MAX} (respectively independently).

As shown in FIG. 12, according to the robot 1, in the above described PTP operation shown in FIG. 8, even when the rotation of the first arm 12 is made lower so that an arrival time TB1 of the first arm 12 may be equal to an arrival time TB2 of the second arm 13, as shown by a solid line in FIG. 12, it is not necessary to make a velocity V1 of the first arm 12 significantly smaller than a velocity V1 shown by a broken line in FIG. 12 (a velocity at which the first arm 12 is rotated at the maximum velocity V1_{MAX}).

That is, a ratio RV1 of the velocity V1 to the maximum velocity V1_{MAX} (the velocity V1 of the first arm 12 in the PTP operation) may be made smaller than the above described ratio RX (see FIGS. 10 and 12). Accordingly, in the PTP operation, even when the second arm 13 is rotated more largely than the first arm 12, the first arm 12 and the second arm 13 may be rotated without excessive degradation of the performances of the first arm 12 and the second arm 13.

Particularly, as described above, the robot 1 selects the action of the first arm 12 with the smaller rotation angle θ1 at an action via a state in which the first arm 12 and the second arm 13 overlap as seen from the second rotation axis O2. Accordingly, in the robot 1 that performs the action via the state in which the first arm 12 and the second arm 13 overlap, the shortest times T1, T2 (the maximum velocities V1_{MAX}, V2_{MAX}) are set as described above, and thereby, the effect that the first arm 12 and the second arm 13 may be rotated without excessive degradation of the performances of the first arm 12 and the second arm 13 may be especially pronouncedly exerted.

Note that, in the above description, the first arm 12 is rotated at the velocity V1 lower than the maximum velocity V1_{MAX} according to the shortest time T2 of the second arm 13, however, the velocity V2 of the second arm 13 may be rotated at the velocity V2 lower than the maximum velocity V2_{MAX} as appropriate.

Further, supposing that a ratio of the velocity V1 (the velocity of the first arm 12 in the PTP operation) to the maximum velocity V1_{MAX} is RV1 and a ratio of the velocity V2 (the velocity of the second arm 13 in the PTP operation) to the maximum velocity V2_{MAX} is RV2, the ratio RV1 and the ratio RV2 preferably satisfy a relationship of 0.8≦RV2/RV1<1.0 and more preferably satisfy a relationship of 0.9≦RV2/RV1<1.0.

As described above, when the ratio RV1 and the ratio RV2 are nearly equal, the first arm 12 and the second arm 13 may be rotated without excessive degradation of the respective performances of the first arm 12 and the second arm 13. That is, if the shortest times T1, T2 (the maximum velocities V1_{MAX}, V2_{MAX}) are set to satisfy the above described relationships, excessive degradation of the respective performances of the first arm 12 and the second arm 13 may be avoided. Further, the rotations of the first arm 12 and the second arm 13 at the ratio RV1 and the ratio RV2 are particularly effective at the above described action via the state in which the first arm 12 and the second arm 13 overlap.

Furthermore, in the robot 1, the shortest time T3 (the maximum velocity V3_{MAX}) of the third arm 14 is set in addition to the above described settings of the shortest times T1, T2 (the maximum velocities V1_{MAX}, V2_{MAX}).

In the robot 1, like the above described relationships between the first arm 12 and the second arm 13, the interferences of the robot 1 with peripherals may be less in an action in which the rotation angle θ2 of the second arm 13 is smaller than the rotation angle θ3 of the third arm 14 compared in an action in which the rotation angle θ2 of the second arm 13 is larger than the rotation angle θ3 of the third arm 14.

Accordingly, in the robot 1, as shown in FIG. 13, the maximum velocity V3_{MAX} of the third arm 14 is made larger (higher) than the maximum velocity V2_{MAX} of the second arm 13. In other words, the shortest time T3 of the third arm 14 when the second arm 13 and the third arm 14 are rotated to the same angle is set to be shorter than the shortest time T2 of the second arm 13.

Note that FIG. 13 shows a velocity VM2 of the second arm 13 and a velocity VM3 of the third arm 14 when the second arm 13 and the third arm 14 are moved at the maximum velocities V2_{MAX}, V3_{MAX} (respectively independently).

As shown in FIG. 14, according to the robot 1, in the above described PTP operation shown in FIG. 8, even when the rotation of the second arm 13 is made lower so that the arrival time TB2 of the second arm 13 may be equal to an arrival time TB3 of the third arm 14, as shown by a solid line in FIG. 14, it is not necessary to make a velocity V2 of the second arm 13 significantly smaller than a velocity V2 shown by a broken line in FIG. 14 (a velocity at which the second arm 13 is rotated at the maximum velocity V2_{MAX}).

That is, a ratio RV2 of the velocity V2 (the velocity of the second arm 13 in the PTP operation) to the maximum velocity V2_{MAX} may be made smaller than the above described ratio RX (see FIGS. 10 and 14). Accordingly, in the PTP operation, even when the third arm 14 is rotated more largely than the second arm 13, the second arm 13 and the third arm 14 may be rotated without excessive degradation of the performances of the second arm 13 and the third arm 14.

Particularly, as described above, the robot 1 selects the action of the second arm 13 with the smaller rotation angle θ2 at an action via a state in which the second arm 13 and the third arm 14 overlap as seen from the second rotation axis O2. Accordingly, in the robot 1 that performs the action via the state in which the second arm 13 and the third arm 14 overlap, the shortest times T2, T3 (the maximum velocities V²_{MAX}, V3_{MAX}) are set as described above, and thereby, the effect that the second arm 13 and the third arm 14 may be rotated without excessive degradation of the performances of the second arm 13 and the third arm 14 may be especially pronouncedly exerted.

Note that, in the embodiment, the second arm 13 is rotated at the velocity V2 lower than the maximum velocity V2_{MAX} according to the shortest time T3 of the third arm 14, however, the velocity V3 of the third arm 14 may be rotated at the velocity V3 lower than the maximum velocity V3_{MAX} as appropriate.

Further, supposing that a ratio of the velocity V2 (the velocity of the second arm 13 in the PTP operation) to the maximum velocity V2_{MAX} is RV2 and a ratio of the velocity V3 (the velocity of the third arm 14 in the PTP operation) to the maximum velocity V3_{MAX} is RV3, the ratio RV2 and the ratio RV3 preferably satisfy a relationship of 0.8≦RV3/RV2<1.0 and more preferably satisfy a relationship of 0.9≦RV3/RV2<1.0.

As described above, when the ratio RV2 and the ratio RV3 are nearly equal, the second arm 13 and the third arm 14 may be rotated without excessive degradation of the respective performances of the second arm 13 and the third arm 14. That is, if the shortest times T2, T3 (the maximum velocities V²_{MAX}, V3_{MAX}) are set to satisfy the above described relationships, degradation of the respective performances of the second arm 13 and the third arm 14 may be avoided. Further, the rotations of the second arm 13 and the third arm 14 at the ratio RV2 and the ratio RV3 are particularly effective at the above described action via the state in which the second arm 13 and the third arm 14 overlap.

As described above, in the robot 1, the maximum velocity V2_{MAX} of the second arm 13 is set to be larger than the maximum velocity V1_{MAX} of the first arm 12. Further, the maximum velocity V3_{MAX} of the third arm 14 is set to be larger than the maximum velocity V2_{MAX} of the second arm 13. Therefore, in the robot 1, the first arm 12, the second arm 13, and the third arm 14 satisfy a relationship of maximum velocity V1_{MAX}<maximum velocity V2_{MAX}<maximum velocity V3_{MAX}. That is, in the robot 1, the first arm 12, the second arm 13, and the third arm 14 satisfy a relationship of shortest time T3<shortest time T2<shortest time T1.

According to the robot 1, in the PTP operation, even when the third arm 14, the second arm 13, and the first arm 12 are rotated to the larger rotation angles in this order, the first arm 12, the second arm 13, and the third arm 14 may be rotated without excessive degradation of the performances of the first arm 12, the second arm 13, and the third arm 14.

Further, in the above description, the robot 1 is set (adapted) so that the maximum velocity V2_{MAX} may be higher than the maximum velocity V1_{MAX}, however, as shown in FIG. 15, the velocity change (gradient) to the maximum velocity V2_{MAX}, i.e., the maximum acceleration A2_{MAX} may be set to be larger than the velocity change (gradient) to the maximum velocity V1_{MAX}, i.e., the maximum acceleration A1_{MAX}.

Even in the configuration, the respective arms 12, 13 may be moved without excessive degradation of the respective performances of the first arm 12 and the second arm 13. Further, adjustment of the acceleration may be easily performed by e.g. adjustment of a reduction ratio of a reducer or adjustment of a control command.

Similarly, the maximum acceleration of the third arm 14 may be set to be larger than the maximum acceleration of the second arm 13.

Further, supposing that an acceleration of the first arm 12 in the PTP operation is A1 and the maximum acceleration of the first arm 12 is A1_{MAX}, and an acceleration of the second arm 13 in the PTP operation is A2 and the maximum acceleration of the second arm 13 is A2_{MAX}, a ratio RA1 of the acceleration A1 to the maximum acceleration A1_{MAX} and a ratio RA2 of the acceleration A2 to the maximum acceleration A2_{MAX} preferably satisfy a relationship of 0.8≦RA2/RA1<1.0 and more preferably satisfy a relationship of 0.9≦RA2/RA1<1.0.

Thereby, like the above described relationships of the ratios RV1, RV2, the first arm 12 and the second arm 13 may be rotated without excessive degradation of the respective performances of the first arm 12 and the second arm 13.

Similarly, supposing that an acceleration of the third arm 14 in the PTP operation is A3 and the maximum acceleration of the third arm 14 is A3_{MAX}, a ratio RA3 of the acceleration A3 to the maximumacceleration A3_{MAX} and the ratio RA2 preferably satisfy a relationship of 0.8≦RA3/RA2<1.0 and more preferably satisfy a relationship of 0.9≦RA3/RA2<1.0.

Furthermore, the above described settings of the maximum velocities V1_{MAX}, V2_{MAX}, V3_{MAX} or the maximum accelerations A1_{MAX}, A2_{MAX}, A3_{MAX} of the respective arms 12 to 14 may be made using capacities of motors, reduction ratios of reducers, etc. singly or in combination.

As above, the robot, the control apparatus, and the robot system according to the invention are explained according to the illustrated embodiments, however, the invention is not limited to those and the configurations of the respective parts may be replaced by arbitrary configurations having the same functions. Further, other arbitrary configurations may be added. Furthermore, the invention may include a combination of two or more arbitrary configurations (features) of the above described respective embodiments.

In the above described embodiments, the number of rotation axes of the robot arm of the robot is six, however, the invention is not limited to that. The number of rotation axes of the robot arm may be e.g. two, three, four, five, or seven or more. Further, in the above described embodiments, the number of arms of the robot is six, however, the invention is not limited to that. The number of arms of the robot may be e.g. two, three, four, five, or seven or more.

Furthermore, in the above described embodiments, the number of robot arms of the robot is one, however, the invention is not limited to that. The number of robot arms of the robot may be e.g. two or more. That is, the robot may be e.g. a multi-arm robot including a dual-arm robot.

In the above described embodiments, regarding conditions (relationships) of an nth rotation axis, an nth arm, an (n+1)th rotation axis, and an (n+1)th arm, the case where n is one, i.e., the case where the first rotation axis, the first arm, the second rotation axis, and the second arm satisfy the conditions is explained, however, the invention is not limited to that. The n may be an integer equal to or more than one, and the same conditions as those in the case where n is one may be satisfied with respect to an arbitrary integer equal to or more than one. Therefore, for example, the case where n is two, i.e., the case where the second rotation axis, the second arm, the third rotation axis, and the third arm may satisfy the same conditions as those in the case where n is one, the case where n is three, i.e., the case where the third rotation axis, the third arm, the fourth rotation axis, and the fourth arm may satisfy the same conditions as those in the case where n is one, the case where n is four, i.e., the case where the fourth rotation axis, the fourth arm, the fifth rotation axis, and the fifth arm may satisfy the same conditions as those in the case where n is one, or, the case where n is five, i.e., the case where the fifth rotation axis, the fifth arm, the sixth rotation axis, and the sixth arm may satisfy the same conditions as those in the case where n is one.

The entire disclosure of Japanese Patent Application No. 2015-175431, filed Sep. 7, 2015 is expressly incorporated by reference herein.

What is claimed is:

1. A robot comprising:
an nth (n is an integer equal to or more than one) arm rotatable about an nth rotation axis; and
an (n+1)th arm provided on the nth arm to be rotatable about an (n+1)th rotation axis in an axis direction different from an axis direction of the nth rotation axis,
wherein a length of the nth arm is longer than a length of the (n+1)th arm,
the nth arm and the (n+1)th arm can overlap as seen from the axis direction of the (n+1)th rotation axis, and
a shortest time taken for a second action of rotating the (n+1)th arm from a first attitude to a first angle is shorter than a shortest time taken for a first action of rotating the nth arm from the first attitude to the first angle.

2. The robot according to claim 1, wherein a maximum velocity of the (n+1)th arm is larger than a maximum velocity of the nth arm.

3. The robot according to claim 1, wherein a maximum acceleration of the (n+1)th arm is larger than a maximum acceleration of the nth arm.

4. The robot according to claim 1, wherein the second action is performed via a state in which the nth arm and the (n+1)th arm overlap as seen from the axis direction of the (n+1)th rotation axis.

5. The robot according to claim 1, further comprising an (n+2)th arm provided on the (n+1)th arm and being rotatable about an (n+2)th rotation axis parallel to the (n+1)th rotation axis,
wherein the (n+1)th arm and the (n+2)th arm can overlap as seen from the axis direction of the (n+1)th rotation axis.

6. The robot according to claim 5, wherein a shortest time taken for a third action of rotating the (n+2)th arm from the first attitude to the first angle is shorter than a shortest time taken for the second action of the (n+1)th arm.

7. The robot according to claim 6, wherein the third action is performed via a state in which the (n+2)th arm and the (n+1)th arm overlap as seen from the axis direction of the (n+1)th rotation axis.

8. The robot according to claim 1, wherein, supposing that a ratio of a velocity of the nth arm to a maximum velocity of the nth arm when the nth arm and the (n+1)th arm are simultaneously rotated is RV1 and a ratio of a velocity of the (n+1)th arm to a maximum velocity of the (n+1)th arm when the nth arm and the (n+1)th arm are simultaneously rotated is RV2, a relationship of 0.8≦RV2/RV1<1.0 is satisfied.

9. The robot according to claim 1, wherein, supposing that a ratio of an acceleration of the nth arm to a maximum acceleration of the nth arm when the nth arm and the (n+1)th arm are simultaneously rotated is RA1 and a ratio of an acceleration of the (n+1)th arm to the maximum acceleration of the (n+1)th arm when the nth arm and the (n+1)th arm are simultaneously rotated is RA2, a relationship of 0.8≦RA2/RA1<1.0 is satisfied.

10. The robot according to claim 1, further comprising a base provided on a proximal end side of the nth arm (n is one).

11. A control apparatus controlling actions of the robot according to claim 1.

12. A robot system comprising:
the robot according to claim 1; and
a control apparatus controlling actions of the robot.
